(19) United States
(12) Patent Application Publication
(10) Pub. No.: US 2007/0170100 A1
(43) Pub. Date: Jul. 26, 2007

(54) Conveyor system for separating scrap components

(76) Inventors: Stephen P. Rogan, St. Louis, MO (US); Glenn Anthony, Eureka, MO (US); David L. Wagner, Dardenne Prairie, MO (US); David R. Guyton, Wentzville, MO (US)

Correspondence Address: Paul M. Denk, Suite 170, 763 S. New Ballas Rd., St. Louis, MO, 63141, US

(21) Appl. No.: 11/646,073

(22) Filed: Dec. 27, 2006

Related U.S. Application Data
(60) Provisional application No. 60/759,444, filed on Jan. 17, 2006.

(51) Int. Cl. B07C 5/04; B07C 5/38

(52) U.S. Cl. 209/632; 209/635

(57) ABSTRACT

This invention relates to the conveying of scrap material along a conveyor, such that when the material reaches the top of its transfer conveyor, as rising up from the shredder, most of the scrap material shredded will be of smaller size, and fall directly into a chute, bin, or onto another conveyor for transit. But, larger scrap material, such as rebars, pipe, and the like, that has not been substantially reduced in size by the shredder or crusher, needs to be separated, and conveyed elsewhere for collection. To achieve such, a transfer roller is provided spacedly from the upper end of the initial scrap conveyor, and that particular transfer roller catches the longer material coming off of the initial conveyor, and sends it further along into another chute, or to another conveyor, for separate collection.

### CROSS REFERENCE TO RELATED APPLICATION

This nonprovisional patent application claims priority to the provisional patent application having Ser. No. 60/759,444, which was filed on Jan. 17, 2006.

### FIELD OF THE INVENTION

This invention relates generally to an apparatus and method for separating scrap components, and more specifically pertains to the integration of various conveyors, into a system, for providing complete separation of larger scrap components from metal or other material scrap that normally has been reduced in size after being processed by a shredder, crusher or pulverizer.

### BACKGROUND OF THE INVENTION

As is well known in the art, pulverizers, crushers, or shredders for processing of scrap metal, or other materials, have long been available in the art. Once they reduce the size of the metal components, that metal needs to be further processed or separated, into various sizes, before it is conveyed and delivered to a blast furnace or for other uses. For example, where the metal being reduced in size may include some reinforcing bars, it is likely that such bars may pass to the bottom cradle of a crusher, and never get processed by its hammers during treatment of the scrap metal delivered therein. Hence, when the entire crushed metal, and the rebars that may be located below the hammers, are subsequently delivered for further processing, the rebars may be of too large of size, sometimes remaining over four feet in length, which makes it difficult to process such scrap for further usage, such as for delivery to a sintering machine, in preparation for deposit into the blast furnace, or related steel making furnaces, as during reusage. Furthermore, such lengths of rebars may have a tendency to clog up the conveyor systems, and the baling mechanisms, that may be used for collection, binding, transfer, and delivery for subsequent usage, and therefore, the concept of this invention is to provide a means for separation of such larger scrap.

The usage of a conveyor system, in combination with a crusher, has been long considered, and for example, U.S. Pat. No. 4,511,302, disclosing a machine for dislodging cans from a compress bale of cans, shows the use of conveyor system for further processing of scrap metal, in this instance, beverage cans, for processing further usage.

The usage of a conveyor that may process and deliver scrap material has been disclosed in the prior art. For example, the patent to Vida, U.S. Pat. No. 3,150,022, shows a continuous process and apparatus for the manufacture and layout of chips into a mosaic sheet material. This patent shows the usage of a conveyor, for processing a plurality of mosaic chips, as passing therealong, and which conveyor has a slot provided therein, which is primarily for use for allowing a forward located backing sheet to apply glue to the underside of the mosaic pieces, and which allows them to be formed into a sheet, as can be noted. It appears that in this instance, the spacing in the conveyor system, is only for use for the application of glue, rather than for any separation purposes.

The patent to Irvin, U.S. Pat. No. 3,469,690, shows a method and means for sorting objects according to length. As can be noted, it includes a series of spaced conveyor sections, having significant gaps located therebetween, so that the various objects or packages will either be passed over the gap, or dropped therethorugh, depending upon their length and size, relative to the conveyor spacings. This relates to the concept of sorting, but it utilizes different technology for achieving it.

The patent to Mellott, et al, U.S. Pat. No. 3,522,880, shows a method and apparatus for conveying and sorting elongated articles. This device shows means for conveying, over conveyor segments, with structural components in the form of boards, and provides for their sorting as they shift along the conveyor system, as can be noted. This device does include the use of rollers, formed within the segments of the conveyor, but once again, the structure and functionality of this device is reasonably distinct from the current concept, of using a singular conveyor for passing large material beyond a segregation point, within the conveyor system.

The patent to Tilby, U.S. Pat. No. 3,873,033, shows methods and apparatus for preparing sugar cane stalks for subsequent processing. In this case, it appears that a series of sugar cane stalks pass from one conveyor to a second conveyor for pressing through a series of rollers, apparently for shedding of their skin or pulp, as can be noted. Separate conveyor sections are used for achieving that purpose. Hence, the concept of using a conveyor system, with rollers there between, for further processing of longer members, such as cane stalks, is shown in this patent, but it is not really operated or used for the same purpose, nor incorporate the related structure, that can be used in the manner of the current invention, and that is to have a singular powered roller for segregating longer pieces of scrap metal, or the like, from the collection of crushed scrap particles.

The patent to Churchland, et al, U.S. Pat. No. 4,546,886, shows another method and apparatus for sorting elongated articles. This particular device does show means for separating longer pieces of articles, such as bars, from shorter ones, as can be noted, as they pass along a conveyor, by utilizing a gap between the ends of the conveyor, and supplemental upper rollers which grab the longer bars, to pass them on, but allowing the smaller ones to fall into a collection bin.

The patent to Bielagus, U.S. Pat. No. 4,836,388, shows an apparatus for separating material by length. This particular device is apparently for separating longer pieces of wood, from shorter segments, by passing them over a series of aligned shafts, each of which includes a series of disks, so that the longer pieces are passed there along, and the shorter pieces fall therethrough, as can be noted. While the concept of moving longer prices over rollers is shown in this patent, it is not the same structure, nor function, of the current invention.

The patent to Quick, U.S. Pat. No. 4,943,328, shows a method and apparatus for selecting wood stock from panels of predetermined sizes. This particular apparatus again includes a multiple roller conveying system, but it is used to provide for the selection and transmission of wood beams along a conveyor system to various work stations, where the beams are appropriately sized, and then glued together apparently to form panels. This is not the structure or the functionality of the current invention, which is generally to select long pieces of scrap metal from smaller pieces.

The patent to Tomat, et al, U.S. Pat. No. 5,400,909, shows a device to discard short bars. As can be seen, there are various types of conveyor chains, which are staggered in the structure of this device, which is not related to the subject matter of this current invention.

The patent to Ryll, U.S. Pat. No. 5,460,272, shows a apparatus for sorting objects, especially those of a flat shape.

The patent to Pylkkanen, et al, U.S. Pat. No. 5,699,919, shows a method and apparatus for removing bark balls from a log flow. The current invention is just not utilized for the identified purposes of this patent.

Finally, the patent to Borel, U.S. Pat. No. 6,082,733, shows a sorting device in a conveyor of plate-like work pieces. This conveyor system is far more complex than what is envisioned for the current development. The device of this identified patent is just made in accordance with quite different structure from what is envisioned for the current invention.

### SUMMARY OF THE INVENTION

This current invention contemplates the formation of a conveyor system used in conjunction with a scrap delivery and separating means, for use for separating larger pieces of scrap that may have escaped crushing, when passing through the various pulverizers or crushers that are normally used to process such scrap components. Generally, this invention relates to the conveying of scrap material, along a conveyor, such that when the material reaches the top of the conveyor, as rising up from the shredder, most of the material shredded will be of smaller size, and will fall directly into a bin, for collection, or for delivery to another conveyor, for transfer off to a location for collection and for subsequent usage. Normally, such scrap is delivered to a sintering plant, where it is then sintered, and then transferred to a blast furnace, or other steel making furnace, as is known in the art.

With the current invention, when larger scrap material is encountered, that has not been reduced substantially in size, such as rebar's, pipes, or the like, it is desirable to convey such material elsewhere, for separate collection, and for further discrete processing. To allow that larger type material to remain with the scrap material can cause problems with its bailing, collection, conveying, and subsequent usage. To achieve that separate conveyance, this invention includes a smaller roller, preferably one that is mechanized, located at the upper edge of an initial scrap conveyor, and this particular roller provides sufficient space between it, and the front edge of the proximate conveyor, so that the smaller crushed scraped material can fall off the conveyor, into a bin, or for further collection. But, when the larger material, such as rebar's, come off of the conveyor, the additional roller catches the long material, and sends it further along into a separate chute, or to another conveyor, for separate collection. Hence, the larger material will be separated, and no longer can clog up the processing of the bulk of the smaller scrap material, for use for other purposes. Hence, this invention is basically the usage of a segregating roller, one that is mechanized, and turned through a motor, such that it can move larger material further on, along a conveyor system, for separation from the preferred reduced sized scrap material.

Essentially, and more specifically, this entire apparatus is for processing of such scrap material, and for its further segregation and usage. When scrap materials are formed, or created, as in a metal shredder, such pieces are delivered out of the shredder and are sent to a conveyor system, where the materials move therealong, generally upon an incline, such that when the material reaches the top of the conveyor, as it rises up from the shredder, most of the material shredded will just be of smaller size, as an example, fist size, and will fall off the end of the conveyor into a chute, or onto another conveyor, for further transfer and processing. But, sometimes, some of the material may be of bigger size, such as the defined rebar steel, or pipe, and have a length much longer, in some instances four feet or more. These types of material cannot be further processed by the machinery. Hence, currently, it needs to be hand removed, which is costly of labor, and dangerous. Thus, this entire invention relates to what takes place at the top of that initial conveyor. Essentially, where an upper pulley or drive roller is located at the top of the conveyor, and around which the end of the conveyor belt turns, there is a space of approximately three feet, more or less, beyond the front of the conveyor, where the smaller scrap material falls through, but the larger material may be cantilevered off the end of the conveyor, during operation. The invention is simply the use of another roller, mechanized, and which is turned by a motor, or through a belt system, and this roller catches the longer material coming off the conveyor, and sends it through its forced journey, to move further along the apparatus, and into a separate chute, where it may drop downwardly, within the chute, and to perhaps another conveyor, for separate processing and collection.

Hence, the concept of this invention is fairly simple, even though the machinery appears to be complex. It is the provision of a separation between larger and longer material coming up a conveyor, for its transfer onto a transfer and separating roller, and into a discrete bin area, for movement out of its chute, and onto another conveyor, or for delivery elsewhere, for further processing. In the meantime, the bulk of the scrap material, of smaller size, as previously explained, will simply fall off the end of the conveyor, into its own chute, for delivery or conveyance elsewhere, for discrete usage and application as previously defined.

It is, therefore, the principle object of this invention to provide a conveyor system, incorporating separating means, for separating smaller shredded metal or other material from larger scrap that needs to be segregated.

Still another object of this invention to provide a conveyor and separator system that can be used in conjunction with metal shredding, crushing, or pulverizing type of equipment.

Still another object of this invention to provide for the mechanization of the processing of scrap material, so as to reduce the need for human labor, and thereby reduce the incidents of injury and damage to any worker, since the entire process is mechanized.

Still another object of this invention is to incorporate a further transfer means in combination with a conveyor system that provides for separating of larger scrap from the shredded smaller metal or materials being processed.

Yet another object of this invention to provide for the mechanized efficient separation of scrap during processing.

These and other objects may become more apparent to those skilled to the art upon review of the summary of the invention as provided herein, and upon undertaking a study of the description of its preferred embodiment, in view of the drawings.

### BRIEF DESCRIPTION OF THE DRAWINGS

In referring to the drawings, FIG. 1 is a side view of the conveyor system for separating scrap components of this invention;

FIG. 2 is a top plan view thereof; and

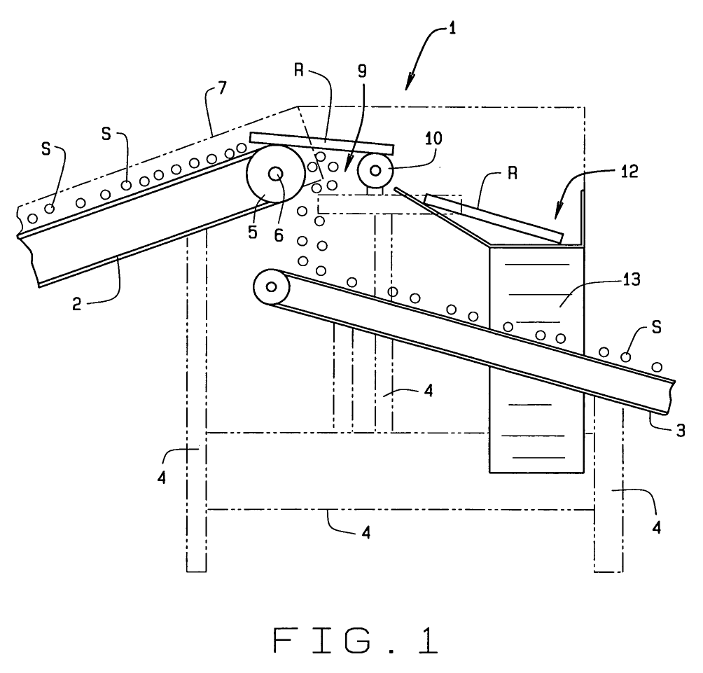

FIG. 3 is a front sectional view taken along the line 3-3 of FIG. 2.

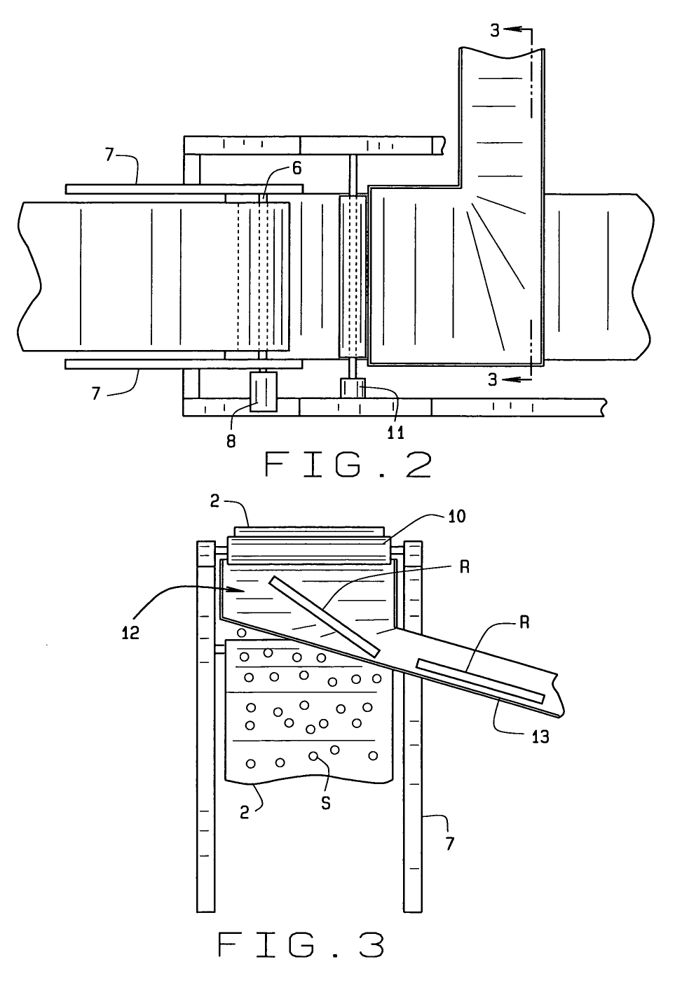

### DESCRIPTION OF THE PREFERRED EMBODIMENT

In referring to the drawings, and in particular FIG. 1, the conveyor apparatus and system for separating scrap materials is readily disclosed, in the side view as shown therein. The apparatus 1 may include a series of conveyor systems, one conveyor as shown at 2 and another at 3. Each of these conveyors have their own separate functionality within the device, as to be explained. The framework 4 which integrates all of these components together, and fixes them into their operative positions, can be readily noted.

Basically, the conveyor 2 has a forward or upper pulley or roller 5 turning on its shaft 6, the shaft 6 being bearing mount within the conveyor frame 7 as can be seen. The shaft 6 may be turned by a energizing motor 8 or it may be that the roller 5 is mounted as an idler roller, and the pulley at the opposite or lower end of the conveyor may be powered by a motor. Nevertheless, the conveyor is capable of shifting upwardly, for conveying the variety of scrap, as noted at S, up towards the end of the conveyor and as it turns around the roller 5. Thus, there is chute, as at 9, formed generally of the end of the conveyor 2, and into and through which the scrap S will pass, for deposit into a chute, or even onto another conveyor, such as the conveyor 3, for transfer of the smaller separated scrap material to another location, for collection, for further usage.

The spacing provided by the chute 9 is formed between the upper edge of the roller 5, and a transfer roller 10 that is mounted forwardly, and spacely, from the conveyor roller 5, as can be seen. The purpose for the spacing, and mounting of the roller 10, is as follows.

Frequently, as previously summarized, larger pieces of scrap material, such as a length of rebar will bypass the shredder or crusher, and yet be deposited upon the lower end of the conveyor 2, and is transferred up the conveyor, along with remaining but abundant amount of smaller scrap S. These types of larger scrap components, such as the rebars R, do need to be separated from the routine scrap. Hence, since the rebar R is too wide to be transferred transversely up the conveyor, normally it undertakes a more longitudinal alignment, upon the surface of the conveyor, as can seen in the manner as shown in FIG. 1. Hence, when the rebar reaches the upper end of the conveyor 2, and its roller 5, it tends, during movement, to cantilever off of the end of the conveyor, and will ride up onto the transfer roller 10, and avoid dropping into the chute 9, during operation.

Since the transfer roller 10 is likewise mechanized, as through the application of a turning motor 11, the transfer roller 10, in this particular instance, rotates with some degree of force in a clockwise direction, and therefore, due to its inherent force, and the friction generated normally from its surface, the rebars are thrusted further forwardly, picked up by the transfer roller, and deposited into a separate chute 12 as can be seen. Hence, at that location, the rebar will be deposited downwardly within the chute 12, along its inclined ramp 13, and be transferred to a separate location, isolated from the collection of the scrap S, for further assembly and separate processing.

In order to assure that the transfer roller 10 can frictionally grip and transfer on the length of bigger scrap R, it may have a frictional surface, such as of rubber, polymer, or other roughened surface, that tends to frictionally engage the rebar, and thrust it forwardly, so as to prevent its deposit in dropping into the chute 9, as can be understood. In the preferred embodiment, a form of rubberized sleeve, approximately one half inch in thickness, more or less, will be applied to the roller, and that rubber has been found to provide sufficient friction to induce the type of results as stated herein, and that is to frictionally grab hold and advance any longer scrap material, such as bars or pipe, further forwardly, for separate collection and processing.

Obviously, all of the various energizing motors 8, 11, or elsewhere within the system, will be regulated and controlled so as to provide for the speed of movement of the conveyor 2, the turning of the pulley or roller 5, and the revolving of the transfer roller 10, so as to coordinate and ensure, depending upon the type of scrap material being processed, that the desirable size scrap S will fall through the chute 9, but the larger materials will be shifted forwardly, into the chute 12, for separation, automatically, and free of labor, from the desirable scrap S sought for separate collection. In the preferred embodiment, the type of motor that may be used to induce rotation of the transfer roller, will preferably provide a speed of rotation for the roller somewhere in the vicinity of 90 RPM. But, obviously, depending upon the circumstances, the roller may be revolved anywhere between 50 to approximately 120 RPM's, during usage. In addition, the size of motor used, at this location is a standard type of electrical motor, and it may cooperate with a speed reducer, that may reduce the speed of rotation of the motor in the range of 15 to 1, more or less, in order to furnish the type of RPM's for the transfer roller as stated above.

Essentially, it can readily understood that the concept of this invention is to provide a horizontal lagged yet motorized pulley or roller, that is positioned at the top of the shredder take-away conveyor. It is designed to remove preferable a high percentage of the rebar and pipe that may have passed through the shredder, and those typically in the range of three to four feet or longer pieces. Most of the material that is conveyed upon the conveyor belt will be small, approximately fist size, and will discharge into the initial chute 9, and either fall downwardly for collection, or onto another conveyor for further transit. But, the longer items of scrap will pass over the mechanized transfer roller 10, and fall into a separate discharge chute, such as the chute 12, and be removed from the scrap materials stream. As stated, frequently, if these items are not removed, they will have to be manually picked off on the downstream equipment. This does present the type of safety concern, as previously described. And, it is likely that if some of this type of larger scrap passes down the initial chute, it in many cases will prematurely damage various other pieces of processing equipment. Hence, the need for application of the transfer roller 10 of this invention.

Variations or modifications to the subject matter of this invention may occur to those skilled to the art upon review of the development as described herein. Such variations, if within the spirit of this development, are intended to be encompassed within the scope of the invention as defined. The description of the preferred embodiment, as depicted in the drawing, and as summarized, is set forth for illustrative purposes only.

1. A conveyor system for separating scrap components, including an initial conveyor for delivering shredded scrap material from a shredder, crusher, and the like, said initial conveyor being disposed and mechanized for moving of the smaller scrap material therealong, a transfer roller, provided spacedly from the front end of the of the initial conveyor, and having sufficient spacing therebetween to allow for the smaller scrap to fall from the conveyor, and into an area for further processing, said transfer roller being powered for turning, said transfer roller designed for receiving larger scrap coming from the initial conveyor and for urging said scrap beyond the initial collection area between the conveyor end and the transfer roller, for transfer to another area for collection, transfer, or further processing.

2. The conveyor system for separating scrap components of claim 1, wherein the initial conveyor is provided upon an incline.

3. The conveyor system for separating scrap components of claim 2, wherein the transfer roller includes a motor means, said motor means turning said transfer roller into a revolving movement, whereby any scrap material encountering the transfer roller will be shifted further forwardly, from the space between the conveyor and the transfer roller, for delivery to a separate location for further processing.

4. The conveyor system for separating scrap components of claim 3, wherein said transfer roller has a frictional surface.

5. The conveyor system for separating scrap components of claim 4, wherein the frictional surface for the transfer roller is formed of one of rubber, polymer, roughened metal, or the like.
